(19) United States
(12) Patent Application Publication
(10) Pub. No.: US 2011/0087623 A1
(43) Pub. Date: Apr. 14, 2011

(54) MECHANISMS FOR BETTER DECISION MAKING AND OUTCOMES

(76) Inventor: Mark Alfred Greenstein, Bethesda, MD (US)

(21) Appl. No.: 12/851,021

(22) Filed: Aug. 5, 2010

Related U.S. Application Data
(60) Provisional application No. 61/231,791, filed on Aug. 6, 2009.

(51) Int. Cl. G06Q 40/00

(52) U.S. Cl. 705/36 T; 705/36 R

(57) ABSTRACT

Methods and systems are disclosed for providing income to persons generally after retirement by addressing the risk of living too long in a way that collectivizes the risk generally avoiding adverse selection and in some cases avoiding or minimizing the use of insurance products.

This application claims the benefit of provisional application 61/231,791 filed Aug. 6, 2009 the disclosure of which is herein incorporated by reference.

### FIELD OF THE INVENTION

The present disclosure relates to methods and systems for providing for, among other things providing income to persons generally after retirement by addressing the risk of living too long in a way that collectivizes the risk generally avoiding adverse selection and in some cases avoiding or minimizing the use of insurance products. Another element helps persons make more informed decisions. It also provides for a more efficient management of money, generally for retirement purposes.

### BACKGROUND OF THE INVENTION

The shift from defined benefit pension plans to defined contribution plans has caused a number of problems. Two of these problems are that persons now have to address their own longevity risk and the other is that the investments used by defined contribution plans are generally more costly and inefficient than those used by defined benefit plans.

This disclosure addresses these issues.

There may be an option for an investor (or in cases outside of investments, a person) to opt out of elements which are generally in their interest, in the case of longevity protection, longevity protection. There also may be other elements such as automatic increases in amounts deducted from pay for contribution to an investment such as in a pension plan, automatic withdrawal amounts, where the person wishes to withdraw additional amounts which could place the individual at risk of running out of funds, taking a loan from a pension plan, which could have the same effect, directing investments into individual investments such as individual stocks, or a different allocation of investments other than that provided under default procedures, for example, during the accumulation and withdrawal phases, each of which may, tend to reduce investment returns or investment risk. While these are generally not positive steps, many individuals do not understand this such as in the case of longevity insurance. The current disclosure can address this by providing that such option to opt out could not be exercised unless a person viewed a presentation on the advantages and in some cases provided interactive evidence that they had viewed the information, such as answering questions, in the preferred embodiment correctly, concerning the advantages. Such evidence could be received and/or recorded by a computer, which may also provide the presentation, such as a video stream over the internet or an intranet that may in some cases use professional colleagues as actors. The presentation as well as the answers in the preferred embodiment would generally be formulated or approved by persons who are independent of persons who may have a financial interest in the decision of the investor, and this would be communicated to the investor, so that the presentation would have greater credibility.

This could also be used to require knowledge prior to engaging in potentially harmful activities such as purchasing cigarettes.

Another aspect of the present disclosure is to avoid insurance in whole or in part by having persons other than insurance companies provide for an income stream based on investments in a manner that collectivizes the longevity risk as is currently the case in a traditional defined benefit plan, but in these cases, with the majority of the income benefits commencing after the typical life expectancy of a person. This aspect would seek to collectivize the longevity risk, but would be different in that a substantial part and perhaps most of the value of the payments would be made after the life expectancies of the individuals. This could be done in a traditional defined benefit plan or using other mechanisms. Therefore, while in current defined benefit plans the amount paid to participants is typically separate from investment experience and begins at retirement in most cases the majority of the amounts paid would be paid substantially beyond retirement and in most cases beyond the life expectancies of the individuals. Also, in a variation, the amounts paid could be dependent in whole or in part on investment experience, and the longevity experience, but the longevity risk itself would be largely or totally collectivized, which means that payments would be made largely or solely based on the average life expectancies of the group, modified by the experience of the actual life spans. This could result in amounts being paid which would be adjusted based on the investment experience and/or the collective longevity experience of the group. The adjustments would be determined by a person or persons such as an actuary or with the assistance of a person such as an actuary with the general goal of maintaining a uniform level of income. We note that similar mechanisms are currently in use in Canada to provide income streams for life beginning at retirement.

Another alternative would be to provide for stated returns to investors which is separated from actual investment returns as in a cash balance plan.

in one preferred embodiment an employer of employees could sponsor such a plan which could be coordinated with a plan such as a section 401(k)-type plan, or could be part of such a plan in a manner designed to provide income in an amount that is related to that provided by the 401(k)-type plan, but generally after the assets in the 401(k)-type plan are anticipated to have been fully or largely exhausted.

In a variation, a provider such as a money manager could offer a pooled investment to more than one plan. The investment experience could be shared but the longevity experience of individuals in each plan would be recorded so that it largely or solely affects the amounts paid to the individuals in that plan and not other plans.

In both the employer sponsored plan context and other contexts an investment component could be coupled with another component that collectivizes the longevity risk. While insurance contracts are available that perform a similar function (e.g., variable annuities) they do so within an insurance product. For a variety of reasons investment components within insurance products are not very popular in the marketplace even though they can address longevity risk. Therefore the present disclosure combines an insurance product which is a deferred annuity, with payments generally commencing after amounts in the related investment account are designed to be largely or totally depleted, with an investment account. In a preferred mode, the payments from each would be related so as to provide a steady stream of income that is similar to that which was formerly provided by defined benefit plans, while affording investors flexibility in the investment component and perhaps related flexibility in the annuity component so long as the ability to collectivize risk is not affected.

Minimum elements regarding the timing and amount of the investment component could be required in order to invest in an insurance product in a manner similar to that used for guaranteed investment contract such as GICs and the equity wash.

Also, the amount of the payments on the annuity could be related to the investment returns of the investments. This could provide more level payments while not affecting the ability to collectivize the risk, and permit the issuer of the annuity to make related investments in a manner that causes the issuers risk to be reduced, in some and perhaps most cases below that when the issuer is required to make variable investments while obligating itself to make fixed payments.

In the employer context, the plan could be funded by contributions from the employee, employer or a third party, for example a government subsidy. The plan could provide for a stated rate of return, based on the formula or a market based formula or a combination. The objective generally is to provide for income in a manner that collectivized the risk of living too long, generally beyond one's life expectancy, so that one's assets for retirement are exhausted. Products or features could be added to minimize the risks of the elements, but in all cases it is anticipated that the pooling or different persons will diminish the longevity risk for individuals in a similar manner as is done with annuities issued by insurance companies. The recording of a person's interest and the calculation of investment return as well as any coordination with another plan or source of retirement income, and the determination of an effectuation of related investments, will be recorded and calculated and effectuated using a computer.

This plan may be part of a new way of investing assets collectively. At least one study has shown that investment returns of assets of section 401(k) plans trail that of defined benefit plans. In order to address this, assets of other plans, including one such as that described above, the assets could be invested collectively in a similar manner as defined benefit plans with one plan pooling assets or with a number of different plans/investors pooling their investments. Unlike a defined benefit plan the investment return could be provided on an individual basis, so long as the assigned returns, from which would generally be subtracted any expenses and or reserves, equaled 100% of the return of investments in the pool. This is similar to the division of a single investment into different elements known as tranches. As an initial matter, persons would generally be assigned a return (based on a combination of investments in the pool) based on their circumstances, typically including their ages or their direction which would be analyzed by a computer using software and related algorithms. Initial purchase transactions would be netted out with any sales and then aggregated. The aggregate of the transactions would then affect the existing investors as they effectively purchased or sold to this aggregate, but the net effect would generally be minute. They may have an opportunity to supplement their information, in which case they will generally be assigned a different investment return. In some cases persons may further modify their assigned return, or in some cases opt out in whole or in part from the plan, but may be required to view a presentation, as described above, and in some cases interact with the presentation, as described above, prior to any such modification. They may be able to view their returns periodically or at any time. A computer would generally be used to store information regarding individuals and assign and calculate investment returns and communicate the returns to the individual investor.

Also, a computer would inform the investment manager of the composition/demographics of the investors and could make composite investments based on the types of persons in the plan (e.g., male female proportions) and their circumstances, and where relevant the elections they have made. In some circumstances investors could choose to have their returns based in larger part or solely on the returns of specific securities, with a possible charge being assessed for this option payable, at least in part, to the fund,

### SUMMARY OF THE DISCLOSURE

Therefore an object of the present invention is to address the problem resulting from the fact that currently the problem of longevity risk and investments for individuals not being addressed as efficiently as in other contexts.

### BRIEF DESCRIPTION OF THE DRAWINGS

FIGS. 1-4 are block diagrams which illustrate the method of the present invention; and

FIG. 5 is a flow chart illustrating, among other things, the use of the Internet for the method of the present invention.

### DETAILED DESCRIPTION OF THE PREFERRED EMBODIMENT

In carrying out the present invention in representative preferred forms thereof, we have provided a representative new and innovative program for the cost effective investment of funds as well as provision of longevity income through collective investment, the combination of investment of funds as currently done for retirement, including plans such as section 401(k)-type plans, with annuities and/or longevity investments, and a technique for assuring that persons that have the opportunity to opt out of annuities or other longevity products or investments do so in a more knowledgeable manner.

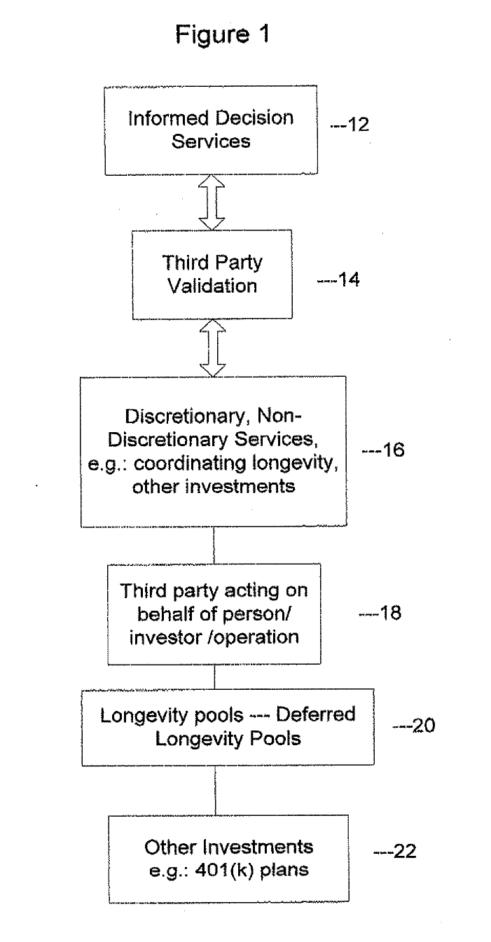

As illustrated in FIG. 1, this disclosure provides for a number of different elements. It provides for informed decision-making (12), the use of third party validation (14); discretionary and non-discretionary services such as coordinating longevity and other investments (16); a third party acting on behalf of another person such as an investor (18); for longevity pools, including deferred longevity pools (20); and the use of other investments such as those in section 401(k) plans (22).

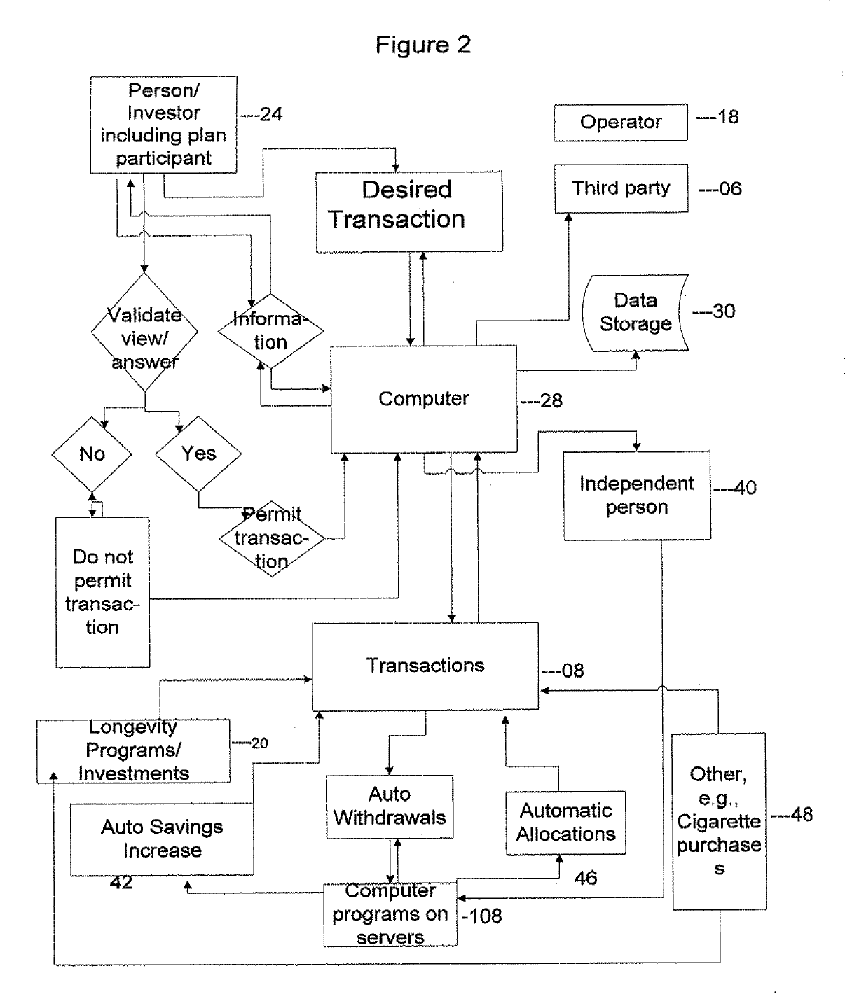

As illustrated in FIG. 2, a person (24) wants to engage in a transaction. The information concerning the transaction is forwarded to a computer (28) which generates information for the individual to review. In some cases a response from the person may be required, including, for example answers to questions indicating that the person has read and reviewed the information. The information may contain information specific to the person from data in a data storage device (30) and the information may be based on algorithms originated or approved by an independent person (40) with limited or no interest in whether the transaction (08) takes place and this may be communicated to the person (24) as well as recorded in the data storage device (30). If the required validation is not provided then the person (24) will not be immediately (nor perhaps ever without validating the viewing of the information) to engage in the transaction (08). These transactions may include whether to opt out of increasing savings in an investment vehicle such as a retirement plan (42), when for example they were place in the plan by a third party (6) such as their employer, whether to take money out of a plan at all or in a different amount than may be advisable or to opt out of automatic withdrawals from a retirement plan (44), whether to accept automatic allocation of investments or opt out (46), whether to participate in longevity programs (20) described below or whether to purchase a package of cigarettes (48). In the case of a purchase of cigarettes the computer (28) and data storage (30) device, operatively connected to software typically located on servers (108) can for example, record the image of the person/investor (24) when they successfully review/answer the information, for example at a computer (28) terminal and transmit it to the vendor so that the person/investor (24) is permitted to make the purchase. When a person opts out of an investment course of action, the opt out information is transmitted to a computer (28) that then causes any investment that has been made that it now opted out of to be liquidated and the amounts transferred back to the investor (24) or to another investment on behalf of the investor (24).

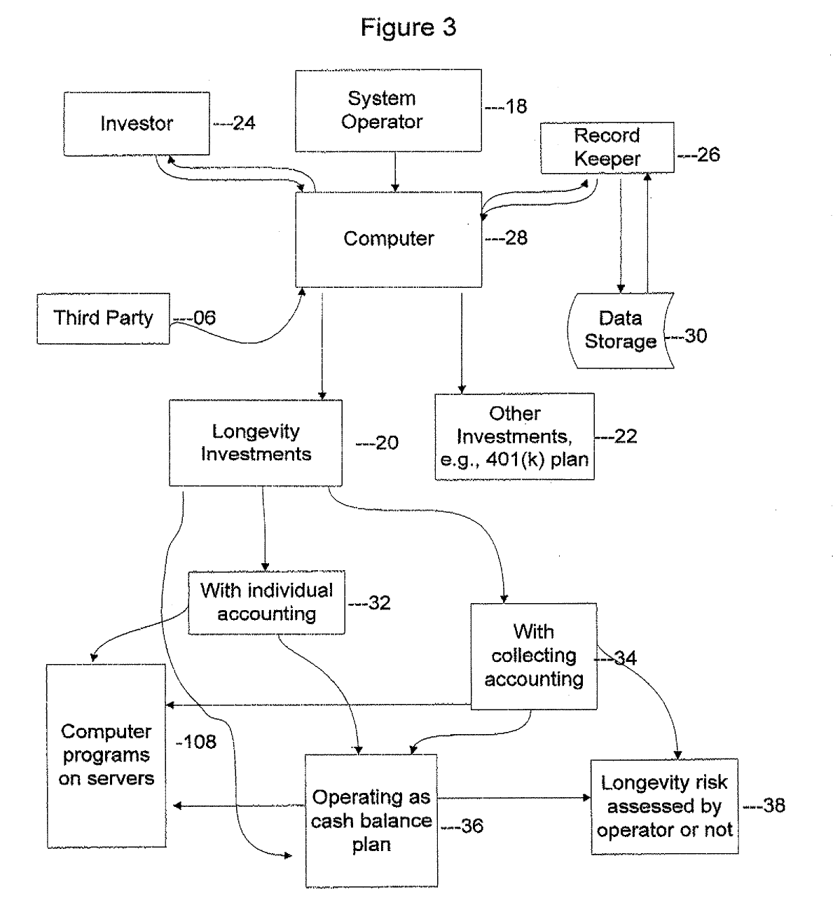

As illustrated in FIG. 3, an investor (24) or one or more third parties (06) such as an employer on behalf of employee/investors, or both invest in longevity investments (20) which are designed to provide income some time after retirement has commenced and may be coordinated with other investments (22) such as investments in a section 401(k) plan (22) for example being designed to commence payments after the assets in a section 401(k) (22) are substantially or totally exhausted, and may be coordinated to provide income and/or investment returns that are related in amount to that provided by other investments (22) such as a section 401(k) plan. Thus investments may be liquidated and paid over a known period which period terminates at the time that longevity payments commence. The longevity payments then make payments until the person/investor dies, or in cases where there is also one or more other contingent beneficiaries, such as a spouse, until the beneficiary dies. Another alternative would be to fund the longevity through the tax system, for example by forgoing all or part of available deductions in exchange for a third party (the government) supplying longevity protection (payments) beginning at an advanced age using algorithms which assign a value in deferred income to earlier forgone income, or in this case the present value of a forgone deduction, similar to or the same as those which increase social security benefits for those who defer payment of benefits. The system operator (18) coordinates the activities, and arranges for a computer to make and forward information to a record-keeper (26) and to a data storage which also tracks and records transactions including investments. The longevity investments may be made with individual accounting where the investment, and payout of a person/investor is individually accounted for (32) with for example a payout that depends on individual circumstances such as the return of other investments (22) such as in section 401(k) plan or may be collectively accounted (34) with returns on a formulaic basis for example related to that of a 401(k) plan as a whole or per a formula. The longevity plan may be operated as a cash balance-type plan (36) with notional accounts for person/investors but with the assets invested collectively for the entire group in the plan. The longevity risk will be collectivized with persons who die earlier contributing some or the full amount of their benefit to the remaining members of the group. In some cases the longevity risk of the group living too long can be partly or fully assumed by the operator (38) or a third party ((06). These activities are implemented using computer programs/software which is operatively connected to computers.

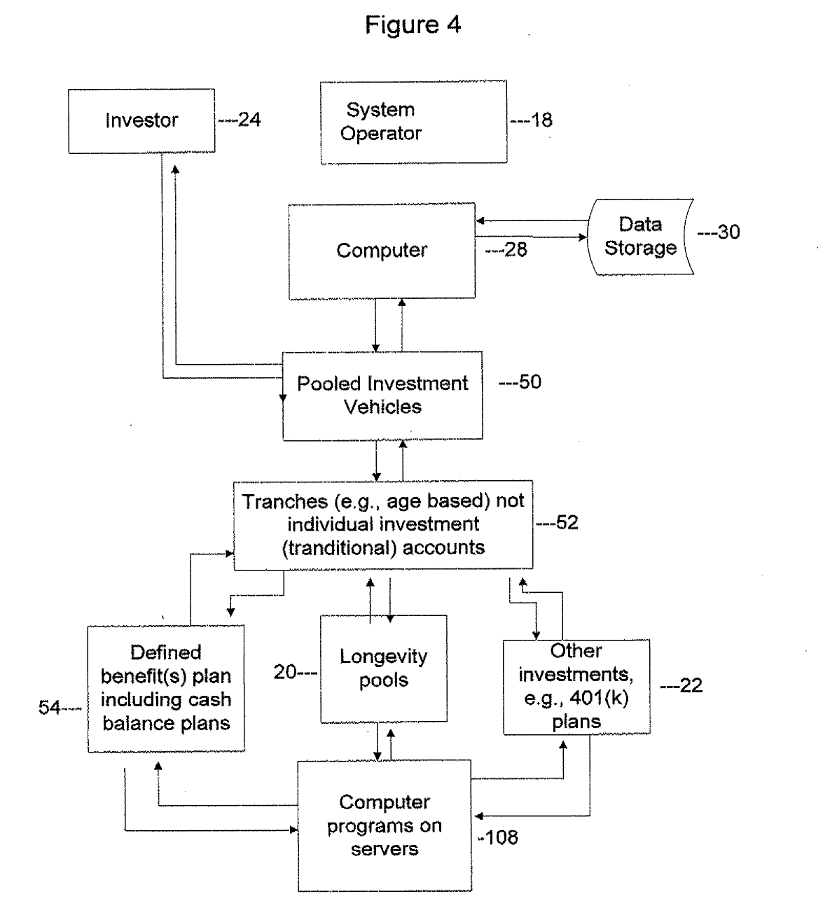

As illustrated in FIG. 4, a person/investor (24) or a third party (06) acting on behalf of the person/investor (24) makes an investment using a computer (28) that may be based, at least in part on data stored in data storage (30) such as the age of the person/investor (24) in a pooled investment vehicle (50) and receives a tranche (52) or an undivided interest in the pool the returns/risk of which reflect the instructions and/or circumstances of the investor (24 as communicated by the investor or a third party (06) on behalf of the investor. A computer (28) receives and records the nature of the tranche (52) which can be adjusted based on new information or the passage of time (aging of the investor (24), in a manner similar to target-date funds). At the time of an initial investment, or during times of adjustment such as aging of investors, the purchase sale orders are aggregated and then the net is communicated and results in generally small changes to an existing holder who, as a practical matter either sells or purchases a portion of their interests to the net of the new/old accounts investors. The total of the tranches (52) are combined and taken into account and processed in a computer (28) and recorded in a data storage device (30). The pooled investment vehicle (50) operator (24) then makes investments based on the totality of the stored information of the persons/investors (24) so that the assigned tranches (52) can better reflect the objectives of the persons/investors (24). These tranches (52) can be utilized by or be part of a defined benefit plan, including a cash balance plan, in which case the tranches would be notional (54), a longevity pool (20), including a defined benefit plan designed to begin payment well after normal retirement age; or other investments (22) such as section 401(k) plans (22). The person/investor (24) may generally access returns, and balances and in some cases may be able to access the formula or a general approximation of the formula on which the returns of his or her assigned tranche are based. The investor may fund the investment through payroll deductions. A computer (28) and related software perform the functions such as payroll deduction and investment in the pooled investment vehicles (50) funds, as well as recording the investment and the assignment of the tranche (52) to an investor. A computer (28) connected to software generally residing on servers (108) may also make the investments for the pooled investment vehicle (50) well as record and coordinate different investments.

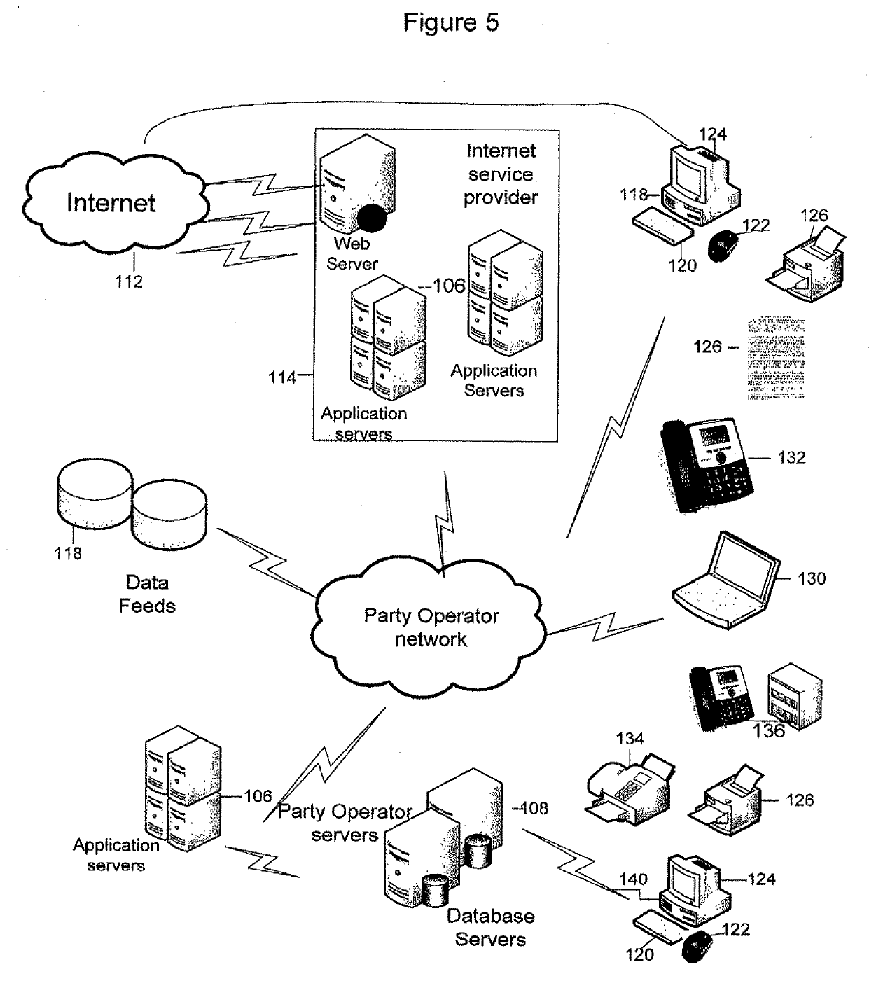

As is illustrated in FIG. 5, the provision of these products and services under the systems and methods of the present invention may require certain computer hardware, including different types of computers (28) but not limited to a mainframe computer or servers(s) (106) for processing large volumes of data stored in types of data storage units (30) such as a data storage unit (108) and a communications system, including but not limited to intranet, internet (112) and other communications vehicles, as known to those skilled in the art. The stored data is taken from data provided by the purchaser (24) or third parties (30) as described above. A computer (28) such as a personal computer or workstation (118) having a hard drive or other storage device, an input device such as a keyboard (120) and mouse (122), and an output device such as a display (124) and printer (126) are operatively connected to the computer (118), as is known to those skilled in the art. In particular, computer programs/software used to implement the communication and transactions as well as their servicing loaded on the application servers (108) are used accessed by, or on behalf of the program operator (18) and are used to transmit under this system and method, in a tangible form to persons/investors (24) as is known to those skilled in the art.

Note that systems and/or methods employing one or more aspects of the present disclosure may, for example, be implemented using one or more systems and/or methods disclosed in Patent Application Pub. No US2002/0169701, entitled “Systems and Methods for Improving Investment Performance”, filed on Feb. 11, 2002, which is hereby expressly incorporated by reference into the present application to the extent not inconsistent with the present disclosure.

While the present invention has been explained in reference to the disclosed embodiments, it is to be understood that other modifications and or variations can be made without departing from the scope of the invention.

What is claimed is:

1. A method for allocating investment returns for at least one investor which is different from at least one other investor who also invests in the same investment vehicle comprising the steps of:
storing personal information corresponding to the investor in a computerized database;
taking account of the information in determining an initial allocation of investment returns;
communicating the allocation of investment returns to the investor or a person acting on behalf of the investor;
providing by a computer the investor or a person acting on behalf of the investor with a choice to provide additional information which is inputted into the computerized data base or to change the allocation;
using at least one computer to determine the allocation of investment returns based on any additional information provided by the investor or on behalf of the investor; and
using a computer to reallocate investment returns in response to a change in age of the investor.

2. The method according to claim 1, further comprising the step of using the at least one computer to automatically reallocate allocation of investment experience within the investment vehicle in response to a change in the retirement investor's employment status.

3. The method according to claim 1, further comprising the step of using the at least one computer to automatically reallocate the investment experience within the investment vehicle in response to a change in the investor's salary.

4. The method according to claim 1, further comprising the step of using the at least one computer to automatically reallocate funds within the retirement investor's investment vehicle in response to a change in the retirement investor's age combined with a change in date.

5. The method according to claim 1, wherein the steps are performed in connection with the investor's participation in an employer-sponsored benefit plan.

6. The method according to claim 1, further comprising the step of making an initial allocation of funds into the retirement investor's investment vehicle, wherein the initial allocation is based, at least in part, on the age of the retirement investor.

7. The method according to claim 1, wherein the investment vehicle is offered in connection with a tax-deferred retirement plan.

8. The method according to claim 1, wherein the investor is automatically enrolled in the retirement plan.

9. The method according to claim 8, further comprising the step of automatically increasing the percentage of pay deducted from the pay of the retirement investor.

10. The method according to claim 9, wherein the automatic increase in the percentage of pay deducted from the pay of the retirement investor is made in accordance with a change in the age of the retirement investor.
